(19) United States
(12) Patent Application Publication
(10) Pub. No.: US 2007/0089798 A1
(43) Pub. Date: Apr. 26, 2007

(54) Line resin tube

(75) Inventors: Shinichi Matsuo, Kanagawa (JP); Atsushi Oshiro, Kanagawa (JP); Ryo Nishino, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: PIOLAX, INC., Yokohama-shi (JP)

(21) Appl. No.: 11/545,764

(22) Filed: Oct. 11, 2006

(30) Foreign Application Priority Data
Oct. 12, 2005 (JP) P2005-297653

(51) Int. Cl. F16L 11/00

(52) U.S. Cl. 138/118; 428/36.91

(57) ABSTRACT

A line resin tube includes a resin composition (C) including 60 to 230 parts by mass of polyamide resin (B) based on 100 parts by mass of polyamide resin (A), wherein the polyamide resin (B) includes 6-nylon and/or denatured 6-nylon, and has a bending modulus of elasticity of 1 GPa or less measured by ASTM D790; and the polyamide resin (A) is obtained by polymerization condensation of xylylene diamine and adipic acid, and has a relative viscosity from 2.0 to 6.0 measured at 25° C. in a solution of 98% concentrated sulfuric acid.

### BACKGROUND OF THE INVENTION

1. Field of the Invention

The present invention relates to a line resin tube suitable for a fuel supply line for an automobile engine.

2. Description of the Related Art

Conventionally, 11-nylon or 12-nylon is used for the resin tube for automobile line because it has flexibility and high degree of freedom in the shape of line.

However, unreactants such as unreacted monomer or oligomer contained in the resin, heat cracking components of 11-nylon or 12-nylon produced during a tube manufacturing process, or various additive components (hereinafter denoted as “residual components”) used for reforming the resin are easily precipitated in 11-nylon or 12-nylon. Since the gases or liquids circulate through the line, the residual components are washed away and removed by the gases or liquids circulating through the line, but can not be completely removed, and are accumulated within the line. Some residual components having viscosity or crystallinity may be gradually accumulated to clog the line, possibly causing a failure in opening or closing the valve. Also, there is a problem that especially when the line resin tube made of 11-nylon or 12-nylon is applied to the fuel supply line for automobile engine, the fuel vapor is easily discharged into the atmosphere, because the anti-permeability of fuel is insufficient.

Thus, various resin materials that supplant 11-nylon or 12-nylon are examined for the resin tube for automobile line. For example, a line resin tube using a resin composition containing 6,6-nylon having a relative viscosity from 4.0 to 6.0, measured at 25° C., in a solution of 98% concentrated sulfuric acid, and 6-nylon having a relative viscosity from 3.0 to 6.0, measured in the same manner, and a plasticizer, their blend percentage being 6, 6-nylon:6-nylon : plasticizer=100:5 to 50:3 to 20, in mass ratio, is disclosed in JP-A-2003-49976.

Also, a line resin tube in which a fluororesin layer composed of fluororesin containing 60 mole % or more of vinylidene fluoride (VDF) and a thermoplastic resin containing 4×10⁻⁵ g equivalent/g or more of terminal amino group are directly bonded, with the fluororesin layer as an internal layer, is disclosed in JP-A-2002-210892.

### SUMMARY OF THE INVENTION

However, the line resin tube of JP-A-2003-49976 and JP-A-2002-210892 have poor flexibility, and is difficult to be press fit at ordinary temperatures, when mounted on the fuel tank, whereby it is required to mount it after once heated and softened.

Also, the line resin tube of JP-A-2002-210892 has the improved anti-permeability of fuel owing to the fluororesin layer laid inside, but because it is required to form the multi-layer, there is a problem that a molding process or a wall thickness control is complex, and take a lot of time. Also, due to the use of fluororesin, there is a problem that the material cost is increased.

Accordingly, aspects of the invention provide a line resin tube that is superior in the anti-permeability of fuel, can be press fit at ordinary temperatures, and has excellent productivity without causing occulusion or contamination of the line due to precipitated residual components.

According to a first aspect of the invention, there is provided a line resin tube includes a resin composition (C) including 60 to 230 parts by mass of polyamide resin (B) based on 100 parts by mass of polyamide resin (A), wherein: the polyamide resin (B) includes 6-nylon and/or denatured 6-nylon, and has a bending modulus of elasticity of 1 GPa or less measured by ASTM D790; and the polyamide resin (A) is obtained by polymerization condensation of xylylene diamine and adipic acid, and has a relative viscosity from 2.0 to 6.0 measured at 25° C. in a solution of 98% concentrated sulfuric acid.

According to the first aspect of the invention, due to the use of the resin composition (C) containing 60 to 230 parts by mass of polyamide resin (B) composed of 6-nylon and/or denatured 6-nylon to 100 parts by mass of polyamide resin (A) obtained by polymerization condensation of xylylene diamine and adipic acid, the line resin tube has the excellent anti-permeability of fuel, adequate flexibility and high degree of freedom in the shape of line, and can be press fit at ordinary temperatures when mounted on the fuel tank. Since the polyamide resin (A) or polyamide resin (B) making up this resin composition (C) has an extremely small content of unreacted residues, the contamination of the inside of the line or occulusion of the line is less likely to occur, without risk that the residual components are precipitated with the elapse of time.

According to a second aspect of the invention according to the first aspect of the invention, the line resin tube is a single layer structure molded of the resin composition (C)

According to the second aspect of the invention, because of the single layer structure, a molding process in the manufacture can be simplified, and the productivity is excellent.

According to a third aspect of the invention according to the first or second aspect of the invention, the line resin tube is included in a bent tube line, an evaporative tube line or a transfer line.

According to the third aspect of the invention, the line resin tube has no contamination or occulusion of the line, because the unreacted residues having viscosity or crystallinity are not precipitated. Also, the line resin tube has excellent anti-permeability of fuel and relatively high flexibility, and is particularly suitable for the bent tube line, the evaporative tube line or the transfer line.

According to a fourth aspect of the invention according to any one of the first to third aspects of the invention, a film thickness of the line resin tube is from 0.5 to 1.5mm.

According to the fourth aspect of the invention, the line resin tube has excellent anti-permeability of fuel and flexibility.

Due to the use of the resin composition (C) containing 60 to 230 parts by mass of polyamide resin (B) composed of 6-nylon and/or denatured 6-nylon to 100 parts by mass of polyamide resin (A) obtained by polymerization condensation of xylylene diamine and adipic acid, the line resin tube has the excellent anti-permeability of fuel, adequate flexibility and high degree of freedom in the shape of line, and can be press fit at ordinary temperatures when mounted on the fuel tank. Also, the residual components causing the contamination of the inside of the line or occulusion of the line are hardly precipitated.

### BRIEF DESCRIPTION OF THE DRAWINGS

These and other objects and advantages of this invention will become more fully apparent from the following detailed description taken with the accompanying drawings in which:

FIG. 1 is a perspective view showing one example of a resin tube of the present invention that is applied to a vapor fuel line of a fuel tank;

FIG. 2 is an enlarged view of a joint portion between a filter and the vapor fuel line in FIG. 1;

FIG. 3 is an explanatory view of a permeability test unit for use in an anti-permeability of fuel test; and

FIG. 4 is an explanatory view showing a test method for secondary workability.

### DETAILED DESCRIPTION OF THE EMBODIMENTS

The present invention will be described below in more detail. A line resin tube of the invention is formed of a resin composition (C) containing polyamide resin (A) obtained by polymerization condensation of xylylene diamine and adipic acid and polyamide resin (B) composed of 6-nylon and/or denatured 6-nylon.

The polyamide resin (A) is obtained by polymerization condensation of xylylene diamine and adipic acid, in which the main component is polymetaxylylene adipamide. This polyamide resin is a resin material having excellent anti-permeability of fuel and very high rigidity of resin itself, but nevertheless has a property of fragility. Therefore, there is a problem that it breaks due to vibration or impact and has almost no degree of freedom in the shape at ordinary temperatures. However, by blending polyamide resin (B), the flexibility can be increased without impairing various physical properties including the anti-permeability of fuel that the polyamide resin (A) has.

The polyamide resin (A) needs to have a relative viscosity (JIS-K6810) from 2.0 to 6.0, measured at 25° C. in a solution of 98% concentrated sulfuric acid, or preferably from 2.0 to 4.0. When the relative viscosity is less than 2.0, there is a problem that the fluidity in molding is so high as to be unsuitable for the extrusion molding. Beyond 6.0, there is a problem that the molding machine is likely to clog due to cooling and solidification.

This polyamide resin (A) is commercially available on the market, for example, a trade name “MX nylon” made by Mitsubishi Gas Chemical Company, Inc.

Polyamide resin (B) is 6-nylon and/or denatured 6-nylon. This polyamide resin is a resin material having excellent flexibility and compatibility with the polyamide resin (A), and therefore can improve the flexibility without impairing the anti-permeability of fuel that the polyamide resin (A) has. Herein, in the invention, the denatured 6-nylon is polymer alloy of 6-nylon obtained by mixing or chemically bonding other monomer to add or strengthen the physical property or function of 6-nylon of base material, and the denatured 6-nylon with the improved bending flexibility by elastomer component is particularly preferable.

The polyamide resin (B) needs to have a bending modulus of elasticity of 1 GPa or less, measured by ASTM D790, preferably from 0.15 to 0.85 GPa. If the bending modulus of elasticity is beyond 1 GPa, it is difficult to improve the resiliency of the resin tube, whereby the degree of freedom in the shape of line is poor, and the press fitting at ordinary temperatures is difficult.

This polyamide resin (B) is commercially available on the market, and for example, 6-nylon is a trade name “UBE nylon” made by Ube Industries, Ltd. Also, the denatured 6-nylon is a trade name “Novamid” made by Mitsubishi Engineering Plastic or a trade name “Glyron” made by MSK.

The resin composition (C) contains the polyamide resin (A) and the polyamide resin (B), its blend ratio being 60 to 230 parts by mass of polyamide resin (B), preferably 100 to 200 parts by mass, to 100 parts by mass of polyamide resin (A). If the polyamide resin (B) is below 60 parts by mass, the resin tube has less excellent flexibility and almost no degree of freedom in the shape of line, and is difficult to be press fit at ordinary temperatures when mounted on the fuel tank. Also, beyond 230 parts by mass, the resin tube has less sufficient strength and anti-permeability of fuel.

The resin composition (C) used for the resin tube of the invention may contain, in addition to the polyamide resin (A) and the polyamide resin (B), various additives usually used for the resin materials of this kind, for example, plasticizer such as sulfonic amide derivative, sulfonic ester derivative, phosphoric ester derivative, phosphazen derivative, carboxylic amide derivative or carboxylic ester derivative, heat resisting agent such as copper halide, hindered phenol compound or aromatic amine, an antioxidant such as phenol, thioether, phosphite or amine based substance, ultraviolet beam absorber such as salicylate, benzoohenone, benzotriazole, imidazole, oxazole, hindered amine, cyanoacrylate, metal complex, or phenyl salicylate, weatherproof improver such as carbon black, copper compound, hindered amine, or phosphoric oxy-acid manganese, antistatic agent such as alkylamine, alkylamide, alkylether, alkylphenylether, glyceric fatty acid ester, sorbitan fatty acid ester, alkylsulfonate, alkylbenzensulfonate, alkylsulfate, alkylphosphate, quaternary ammonium salt or alkylbetaine, inorganic flame retardant such as red phosphorus, tin oxide, zirconium hydroxide, barium metaborate, aluminum hydroxide or magnesium hydroxide, organic flame retardant such as halogen, phosphoric ester, melamine, or cyanuric acid, flame retardant assistant such as antimoney trioxide, heat stabilizer such as hindered amine, tin compound or epoxy compound, wear resistance improver such as molybdenum disulfide, graphite, polyethylene, poly-4-ethylene fluoride or silicone, nuclear agent, mold releasing agent, oil agent, pigment, and dye. The content of these additives is preferably 5 parts by mass or less to a total of 100 parts by mass of polyamide resin (A) and polyamide resin (B), more preferably 3 parts by mass or less.

The resin tube of the invention is obtained by dry blending polyamide resin (A) and polyamide resin (B) before molding, and further adding the above additives, as needed, to produce the resin composition (C) and extruding this resin composition (C) from a die of the molding machine in the shape of tube.

Since the resin tube of the invention is a single layer structure composed of the resin composition (C), the manufacturing process is simple, and the film thickness of the resin tube is easily adjusted.

The film thickness of the resin tube is preferably from 0.5 to 1.5 mm, and more preferably from 0.8 to 1.2 mm. If the film thickness is within the above range, the line resin tube has excellent strength, anti-permeability of fuel and flexibility.

The resin tube thus obtained can be employed as various kinds of pipe for the automobile fuel system, and suitably employed as the bent tube line, evaporative tube line or transfer line for the fuel because it is particularly excellent in the oil resistance and anti-permeability of fuel.

The examples of uses of the line resin tube of the invention will be described below.

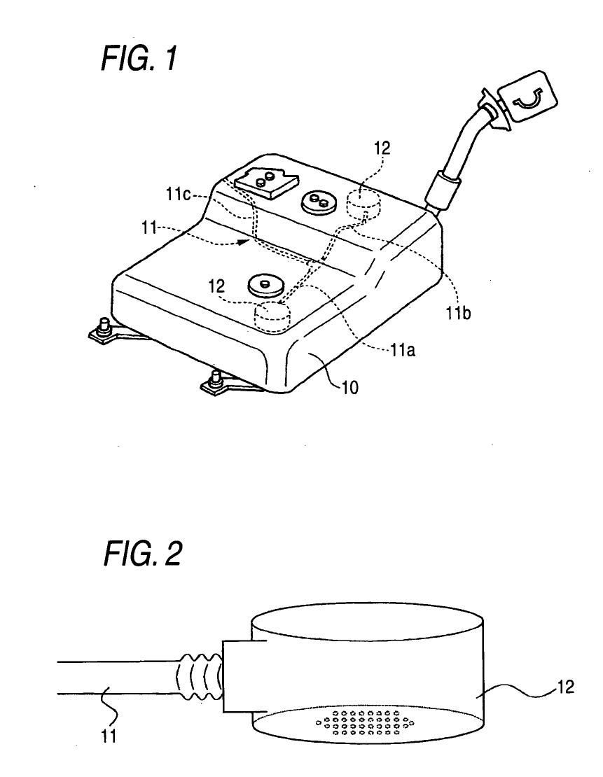

FIG. 1 shows one example of a vapor fuel line built into a fuel tank for automobile, and FIG. 2 is an enlarged view of a joint portion between a valve 12 and the vapor fuel line 11 in FIG. 1.

That is, this vapor fuel line 11 is attached on an inner face of an upper wall of the fuel tank 10. The vapor fuel line 11 has two branch pipes 11a and 11b having a valve 12 at the end, and an outlet pipe 11c extends from a junction of the branch pipes 11a and 11b out of the fuel tank 10. The outlet pipe 11c is connected to a caster through an external line, not shown.

The fuel tank 10 is coated with paint outside, and thermally dried, after various devices including the vapor fuel line 11 are installed inside. At this time, since the fuel tank is placed at high temperatures, the devices installed inside must have heat resistance.

In this regard, if the resin tube of the invention is employed as the vapor fuel line 11, the connection part between the valve 12 and the branch pipe is kept air tight at high temperatures, because the resin tube is made of the resin composition containing polyamide resin (polyamide resin (A)) obtained by polymerization condensation of xylylene diamine and adipic acid as the base.

Also, the resin tube of the invention is relatively flexible, and easily bent to adapt to the internal shape of the fuel tank 10. Further, the resin tube can be press fit into the valve 12 at ordinary temperatures, whereby the mounting work is simple. Further, since the resin tube has excellent fuel resistance, sufficient durability over long term, and almost no precipitation of residual components, the contamination or occulusion of the line is less likely to occur.

### EXAMPLE 1

A resin composition was produced by adding and mixing 100 parts by mass of denatured 6-nylon (trade name “Novamid ST145” made by Mitsubishi Engineering Plastic) having a bending modulus of elasticity of 0.83 GPA, measured by ASTM D790, to 100 parts by mass of polymetaxylylene adipamide (trade name “MX nylon S6007” made by Mitsubishi Gas Chemical Company, Inc.) having a relative viscosity from 2.7, measured at 25° C., in a solution of 98% concentrated sulfuric acid. The resin composition was molded like a tube having an outer diameter of 8 mm, an inner diameter of 6 mm and a wall thickness of 1 mm by an extrusion molding machine to obtain the resin tube of example 1.

### EXAMPLE 2

A resin composition was produced by adding and mixing 200 parts by mass of denatured 6-nylon (trade name “Novamid ST145” made by Mitsubishi Engineering Plastic) having a bending modulus of elasticity of 0.83 GPA, measured by ASTM D790, to 100 parts by mass of polymetaxylylene adipamide (trade name “MX nylon S6007” made by Mitsubishi Gas Chemical Company, Inc.) having a relative viscosity from 2.7, measured at 25° C., in a solution of 98% concentrated sulfuric acid. Using this resin composition, the resin tube of example 2 was produced in the same manner as example 1.

### Comparative Example 1

A resin composition was produced by adding and mixing 50 parts by mass of denatured 6-nylon (trade name “Novamid ST145” made by Mitsubishi Engineering Plastic) having a bending modulus of elasticity of 0.83 GPA, measured by ASTM D790, to 100 parts by mass of polymetaxylylene adipamide (trade name “MX nylon S6007” made by Mitsubishi Gas Chemical Company, Inc.) having a relative viscosity from 2.7, measured at 25° C., in a solution of 98% concentrated sulfuric acid. Using this resin composition, the resin tube of comparative example 1 was produced in the same manner as example 1.

### Comparative Example 2

A resin composition was produced by adding and mixing 300 parts by mass of denatured 6-nylon (trade name “Novamid ST145” made by Mitsubishi Engineering Plastic) having a bending modulus of elasticity of 0.83 GPA, measured by ASTM D790, to 100 parts by mass of polymetaxylylene adipamide (trade name “MX nylon S6007” made by Mitsubishi Gas Chemical Company, Inc.) having a relative viscosity from 2.7, measured at 25° C., in a solution of 98% concentrated sulfuric acid. Using this resin composition, the resin tube of comparative example 2 was produced in the same manner as example 1.

### Comparative Example 3

Using a resin composition of 11-nylon (trade name “BESN P20TL” made by Alukema), the resin tube of comparative example 3 was produced in the same manner as example 1.

For each of the resin tubes, the residual components, the anti-permeability of fuel, and the secondary workability (heat bending) were measured. The measurement results are listed in Table 1.

Residual Components

A fuel (Fuel C+ methanol 15vol %) of 80 cc and each resin tube 15 g were inputted into a conical flask, and heated at 40° C. for 168 hours while agitating once each day. After the heat treatment, the fuel was cooled to 0° C. Then, fuel of 5 cc was taken on a Petri dish, and dried. The weight of precipitated residual components was measured.

Anti-permeability of Fuel

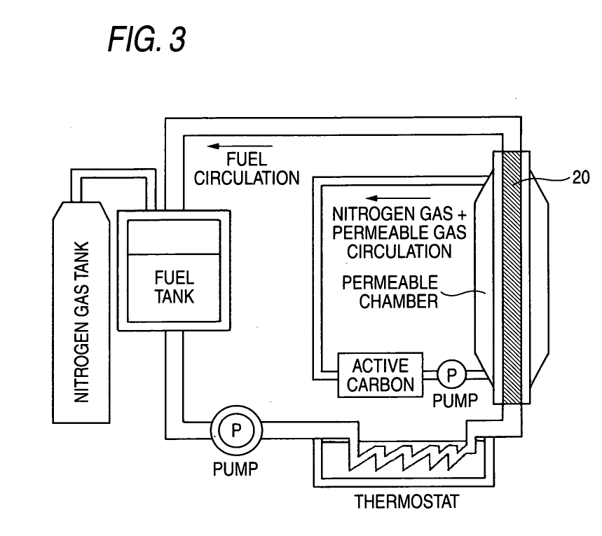

Using a permeability test unit as shown in FIG. 3 under the conditions where the temperature was 60° C. and the pressure was 0.2 MPa, fuel (Fuel C+ methanol 15vol %) was circulated through a specimen 20 obtained by cutting each resin tube in a length of 2000 mm, fuel vapor permeated through the specimen 20 was withdrawn in a permeable chamber, fuel vapor within the permeable chamber was circulated together with nitrogen gas, fuel vapor was captured with active charcoal, the permeation amount of fuel was measured from a change in the weight of active charcoal, and the permeation factor of the resin tube was calculated.

Secondary Workability (Bending Resistance)

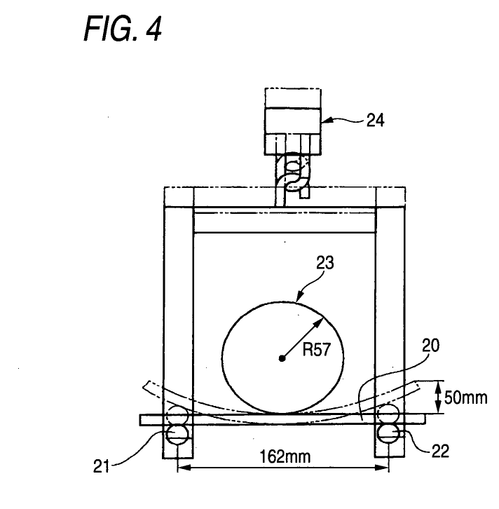

The bending resistance was measured under room temperature by a method as shown in FIG. 4. That is, a specimen 20 obtained by cutting each resin tube in a length of 280 mm was placed on a pair of axes 21 and 22 confronted in parallel with a width of 162 mm, a central part of the specimen 20 was pressed by a mandrel 23, and the load was measured by a load cell 24 when the moving amount at the distal end of the specimen was 50 mm.

TABLE 1
Measurement results

| | | | Comp. | Comp. | Comp. |
|---|---|---|---|---|---|
| | Ex. 1 | Ex. 2 | ex. 1 | ex. 2 | ex. 3 |
| Residual component | 0.16 | 0.13 | 0.15 | 0.12 | 1.62 |
| extraction ratio (%) | | | | | |
| Permeability factor | 192 | 272 | 305 | 127 | 538 |
| (g · mm/m² · 24 h) | | | | | |
| Bending resistance | 22 | 18 | 14 | 39 | 14 |
| (N) | | | | | |

From the above results, the resin tubes of comparative examples 1 and 3 were excellent in the secondary workability, and inferior in the anti-permeability of fuel.

Also, the resin tube of comparative example 2 was excellent in the anti-permeability of fuel but inferior in the secondary workability, and was difficult to be press fit at ordinary temperatures.

Also, the resin tube of comparative example 3 had a large precipitation amount of residual components.

On the other hand, the resin tubes of examples 1 and 2 had almost no precipitation amount of residual components, and was excellent in the anti-permeability of fuel and secondary workability, and further can be press fit at ordinary temperatures.

The line resin tube of the invention can be suitably employed for the fuel supply line for automobile.

What is claimed is:

1. A line resin tube comprising
a resin composition (C) including 60 to 230 parts by mass of polyamide resin (B) based on 100 parts by mass of polyamide resin (A), wherein:
the polyamide resin (B) includes 6-nylon and/or denatured 6-nylon, and has a bending modulus of elasticity of 1 GPa or less measured by ASTM D790; and
the polyamide resin (A) is obtained by polymerization condensation of xylylene diamine and adipic acid, and has a relative viscosity from 2.0 to 6.0 measured at 25° C. in a solution of 98% concentrated sulfuric acid.

2. The line resin tube according to claim 1, wherein
the line resin tube is a single layer structure molded of the resin composition (C).

3. The line resin tube according to claim 1, wherein
the line resin tube is included in a bent tube line, an evaporative tube line or a transfer line.

4. The line resin tube according to claim 1, wherein
a film thickness of the line resin tube is from 0.5 to 1.5 mm.
